(19) United States
(12) Patent Application Publication
(10) Pub. No.: US 2025/0276309 A1
(43) Pub. Date: Sep. 4, 2025

(54) EXHAUST GAS PURIFICATION DEVICE AND METHOD FOR MANUFACTURING EXHAUST GAS PURIFICATION DEVICE

(71) Applicants: Takahiro NISHIO, Nagoya-shi (JP); Shogo SHIRAKAWA, Toyota-shi (JP); Hiroki SHIRAKAWA, Nagakute-shi (JP); Shohei KANNO, Toyota-shi (JP); Tomomasa AIKAWA, Hukuroi-shi (JP); Takahiro NOGUCHI, Hamamatsu-shi (JP); Hiroki NIHASHI, Hamamatsu-shi (JP)

(72) Inventors: Takahiro NISHIO, Nagoya-shi (JP); Shogo SHIRAKAWA, Toyota-shi (JP); Hiroki SHIRAKAWA, Nagakute-shi (JP); Shohei KANNO, Toyota-shi (JP); Tomomasa AIKAWA, Hukuroi-shi (JP); Takahiro NOGUCHI, Hamamatsu-shi (JP); Hiroki NIHASHI, Hamamatsu-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 19/044,717

(22) Filed: Feb. 4, 2025

(30) Foreign Application Priority Data
Mar. 1, 2024 (JP) 2024-031635

(51) Int. Cl. B01J 35/00; B01D 53/94; B01J 23/63; B01J 35/30; B01J 35/45; B01J 37/02; B01J 37/08; F01N 3/28

(52) U.S. Cl. CPC B01J 35/19; B01D 53/9413; B01J 23/63; B01J 35/393; B01J 35/394; B01J 35/45; B01J 37/0205; B01J 37/0236; B01J 37/088; F01N 3/2803; B01D 2255/1025; B01D 2255/9035; B01D 2255/908; F01N 2370/02

(57) ABSTRACT

The exhaust gas purification device includes: a substrate including an upstream end and a downstream end; a first catalyst layer formed in a first region extending between the downstream end and a first position; and a second catalyst layer formed in a second region extending between the upstream end and a second position and contains second rhodium particles. The first catalyst layer contains a first rhodium-containing catalyst and a first cerium-containing oxide. A mean of a particle size distribution of first rhodium particles contained in the first rhodium-containing catalyst is from 2 nm to 10 nm. An amount of rhodium dissolved into the first metal oxide carrier based on a total weight of rhodium contained in the first rhodium-containing catalyst is less than 17 wt %. A cerium content (g/L) in the first catalyst layer is equal to or greater than a cerium content (g/L) in the second catalyst layer.

### CROSS REFERENCE TO RELATED APPLICATIONS

The present application claims priority from Japanese patent application JP 2024-031635 filed on Mar. 1, 2024, the entire content of which is hereby incorporated by reference into this application.

### BACKGROUND

### Technical Field

The present disclosure relates to an exhaust gas purification device and a method for manufacturing the exhaust gas purification device.

### Background Art

An exhaust gas discharged from an internal combustion engine used in a vehicle, such as an automobile, contains a harmful component, such as carbon monoxide (CO), hydrocarbon (HC), and nitrogen oxide (NOx). Regulations on emission amounts of these harmful components have been tightened year by year. To remove these harmful components, a noble metal, such as platinum (Pt), palladium (Pd), and rhodium (Rh), has been used as a catalyst.

An exhaust gas purification device needs to efficiently remove NOx in both of an oxygen deficient atmosphere and an oxygen excess atmosphere. For this reason, a material having an ability to absorb and release oxygen to reduce fluctuation of the atmosphere, i.e., an oxygen storage capacity (OSC), is used for the exhaust gas purification device.

JP 2023-134093 A discloses an exhaust gas purification catalyst that is disposed in an exhaust pipe of an internal combustion engine and purifies an exhaust gas discharged from the internal combustion engine. The exhaust gas purification catalyst includes a substrate and a catalyst layer formed on a surface of the substrate. The catalyst layer has a stacked structure of at least two layers. A first layer consists of an upstream catalyst layer, which is formed from an exhaust gas flow-in side end of the exhaust gas purification catalyst toward an exhaust gas flow-out side, and a downstream catalyst layer, which is formed from an exhaust gas flow-out side end of the exhaust gas purification catalyst toward an exhaust gas flow-in side. The upstream catalyst layer and the downstream catalyst layer each include at least: Pd and/or Rh as a catalyst metal; and an OSC material containing Ce. A second layer includes at least: Pt as a catalyst metal; and an NOx storage material. In the first layer, when C1 is an amount of CeO₂ contained in the upstream catalyst layer and C2 is an amount of CeO₂ contained in the downstream catalyst layer, the relationship C1<C2 is satisfied.

### SUMMARY

NOx removal performance of the exhaust gas purification catalyst device described in JP 2023-134093 A tends to deteriorate under a high temperature environment. The present disclosure provides an exhaust gas purification device having a high OSC and allowing efficient removal of harmful components even after exposure to a high temperature environment, and a method for manufacturing the same.

The present disclosure includes the following aspects.

[Aspect 1] An exhaust gas purification device comprising:
a substrate including an upstream end through which an exhaust gas is introduced into the exhaust gas purification device and a downstream end through which the exhaust gas is discharged from the exhaust gas purification device;
a first catalyst layer formed in a first region, the first region extending between the downstream end and a first position, the first position being at a first distance from the downstream end toward the upstream end, the first catalyst layer containing a first rhodium-containing catalyst and a first cerium-containing oxide, the first rhodium-containing catalyst containing a first metal oxide carrier and first rhodium particles supported on the first metal oxide carrier, a mean of a particle size distribution of the first rhodium particles being from 2 nm to 10 nm, an amount of rhodium dissolved into the first metal oxide carrier to form a solid solution based on a total weight of rhodium contained in the first rhodium-containing catalyst being less than 17 wt %; and
a second catalyst layer formed in a second region, the second region extending between the upstream end and a second position, the second position being at a second distance from the upstream end toward the downstream end, the second catalyst layer containing second rhodium particles,
wherein a cerium content in the first catalyst layer based on a volume of the substrate in the first region is equal to or greater than a cerium content in the second catalyst layer based on a volume of the substrate in the second region.
   [Aspect 2] The exhaust gas purification device according to Aspect 1,
wherein the amount of rhodium dissolved into the first metal oxide carrier to form a solid solution based on the total weight of rhodium contained in the first rhodium-containing catalyst is 3 wt % or less.
   [Aspect 3] The exhaust gas purification device according to Aspect 1 or 2,
wherein the cerium content in the first catalyst layer based on the volume of the substrate in the first region is one to nine times the cerium content in the second catalyst layer based on the volume of the substrate in the second region.
   [Aspect 4] The exhaust gas purification device according to any one of Aspects 1 to 3,
wherein the second catalyst layer contains a second rhodium-containing catalyst containing a second metal oxide carrier and the second rhodium particles supported on the second metal oxide carrier.
   [Aspect 5] A method for manufacturing an exhaust gas purification device, the method comprising:
(a) preparing a first rhodium-containing catalyst containing a first metal oxide carrier and first rhodium particles supported on the first metal oxide carrier;
(b) forming a first catalyst layer containing the first rhodium-containing catalyst and a first cerium-containing oxide in a first region extending between a downstream end of a substrate and a first position, the first position being at a first distance from the downstream end toward an upstream end; and
(c) forming a second catalyst layer containing second rhodium particles in a second region extending between the upstream end of the substrate and a second position, the second position being at a second distance from the upstream end toward the downstream end,
wherein the preparing the first rhodium-containing catalyst includes:
   (i) impregnating the first metal oxide carrier with a rhodium compound solution;
   (ii) drying the first metal oxide carrier impregnated with the rhodium compound solution to obtain a first rhodium-supporting metal oxide; and
   (iii) heating the first rhodium-supporting metal oxide to a temperature within a range from 850° C. to 1000° C. in an atmosphere containing carbon monoxide at a concentration of 0.01 vol % to 5 vol % with a balance being an inert gas to obtain the first rhodium-containing catalyst, and
wherein a cerium content in the first catalyst layer based on a volume of the substrate in the first region is equal to or greater than a cerium content in the second catalyst layer based on a volume of the substrate in the second region.

The exhaust gas purification device of the present disclosure has a high OSC and allows efficient removal of harmful components even after exposure to a high temperature environment.

### BRIEF DESCRIPTION OF THE DRAWINGS

FIG. 1 is an enlarged end view of a main part of an exhaust gas purification device according to an embodiment taken along a surface parallel to a flow direction of an exhaust gas and schematically illustrating a configuration at and near a partition wall of a substrate;

FIG. 2 is a perspective view schematically illustrating an example of the substrate;

FIG. 3 is an enlarged end view of a main part of an exhaust gas purification device according to a modified embodiment taken along a surface parallel to a flow direction of an exhaust gas and schematically illustrating a configuration at and near a partition wall of a substrate;

FIG. 4 is a graph showing Cmax of exhaust gas purification devices of Examples and Comparative Examples after aging at a high temperature;

FIG. 5 is a graph showing NOx-T50 of exhaust gas purification devices of Examples and Comparative Examples after aging at a high temperature; and

FIG. 6 is a graph showing a relationship between a percentage of dissolved Rh and NOx-T50 in Reference Examples 1 to 6.

### DETAILED DESCRIPTION

The following describes embodiments with reference to the drawings as appropriate. In the drawings referred in the following description, the same reference numerals may be used for the same members or the members having similar functions, and their repeated explanations may be omitted in some cases. For convenience of explanation, dimensional ratios and shapes of respective units in the drawings may be exaggerated and may differ from actual dimensional ratios and shapes in some cases.

Unless otherwise described, a numerical range expressed herein using the term “to” includes respective values described before and after the term “to” as a lower limit and an upper limit. The upper limits and the lower limits disclosed herein can be used alone or in any combination.

Unless otherwise described, the terms “comprise”, “include”, and “contain” herein mean that an additional component or element may be contained, and encompass the term “consisting essentially of” and the term “consisting of.” The term “consisting essentially of” means that an additional component or element having substantially no adverse effect may be contained. While the term “consisting of” means including only described materials or elements, it does not exclude further inclusion of inevitable impurities.

The term “on” herein encompasses both of “directly on” and “indirectly on” insofar as it is not especially specified in the context.

### I. Exhaust Gas Purification Device

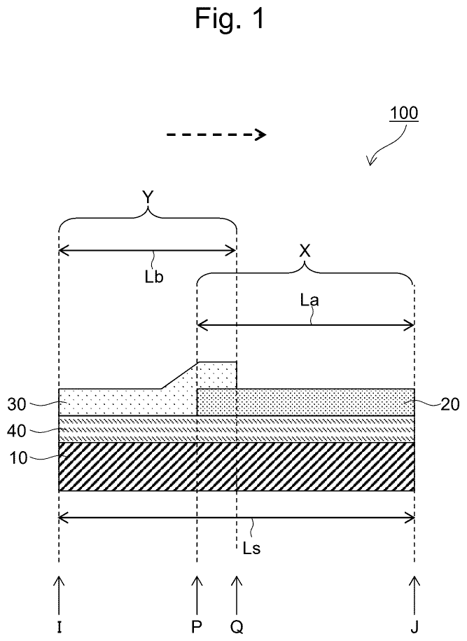

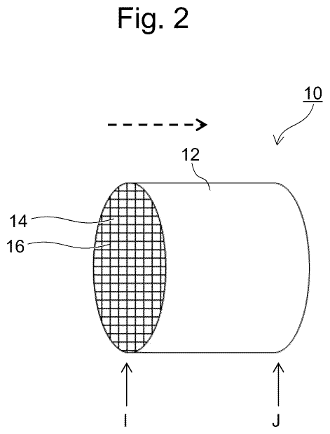

An exhaust gas purification device 100 according to an embodiment is described with reference to FIGS. 1 and 2. The exhaust gas purification device 100 according to the embodiment includes a substrate 10, a first catalyst layer 20, a second catalyst layer 30, and a third catalyst layer 40.

### (1) Substrate 10

The substrate 10 is not specifically limited, and any substrate that can be used as the substrate for the exhaust gas purification device can be used. For example, as illustrated in FIG. 2, the substrate 10 may include a frame portion 12 and partition walls 16 that partition a space surrounded by the frame portion 12 to define a plurality of cells 14. The frame portion 12 and the partition walls 16 may be integrally formed. The frame portion 12 may have any shape, such as a cylindrical shape, an elliptical cylindrical shape, or a polygonal cylindrical shape. The partition walls 16 are disposed to extend between a first end (first end surface) I and a second end (second end surface) J of the substrate 10 to define the plurality of cells 14 extending between the first end I and the second end J. Each cell 14 may have any cross-sectional shape, such as a quadrilateral shape (e.g., a square, a parallelogram, a rectangular, or a trapezoid), a triangular shape, and any other polygonal shape (e.g., a hexagon or an octagon), or a circular shape. Each of the plurality of cells 14 may be closed at either of the first end I or the second end J, or may be opened at both of the first end I and the second end J.

The “volume of the substrate” herein means the total volume of the frame portion 12, the partition walls 16, and the cells 14, that is, the total volume of the frame portion 12 and the space surrounded by the frame portion 12.

Examples of the material of the substrate 10 include ceramic, such as cordierite (2MgO·2Al₂O₃·5SiO2), aluminum titanate, silicon carbide, silica, alumina, and mullite, and a metal, such as stainless steel containing chromium and aluminum. These materials allow the exhaust gas purification device 100 to exhibit high exhaust gas purification performance even under a high temperature condition. From the aspect of cost reduction, the substrate 10 may be made from cordierite.

In FIGS. 1 and 2, the dashed arrows indicate a flow direction of an exhaust gas in the exhaust gas purification device 100 and the substrate 10. The exhaust gas is introduced into the exhaust gas purification device 100 through the first end I, and discharged from the exhaust gas purification device 100 through the second end J. Therefore, hereinafter, the first end I is also referred to as an upstream end I and the second end J is also referred to as a downstream end J as appropriate. A length between the upstream end I and the downstream end J, that is, the total length of the substrate 10, is herein denoted as Ls.

### (2) First Catalyst Layer 20

The first catalyst layer 20 is disposed on the substrate 10 and extends across a first region X extending between the downstream end J and a first position P, which is at a first distance La from the downstream end J toward the upstream end I (that is, in a direction opposite to the flow direction of the exhaust gas). The first distance La may be from 40% to 65% of the total length Ls of the substrate 10.

The first catalyst layer 20 contains a first Rh-containing catalyst. The first Rh-containing catalyst contains a first metal oxide carrier and first Rh particles supported on the first metal oxide carrier.

Examples of the first metal oxide carrier include an oxide of at least one metal selected from the group consisting of metals of the group 3, the group 4, and the group 13 in the periodic table of elements and lanthanoid-based metals. When the first metal oxide carrier contains two or more metal elements, the first metal oxide carrier may be a mixture of oxides of the two or more metal elements, may be a composite oxide containing the two or more metal elements, or may be a mixture of an oxide of at least one metal element and at least one composite oxide.

For example, the first metal oxide carrier may be an oxide of at least one metal selected from the group consisting of scandium (Sc), yttrium (Y), lanthanum (La), cerium (Ce), neodymium (Nd), samarium (Sm), europium (Eu), lutetium (Lu), titanium (Ti), zirconium (Zr), and aluminum (Al), an oxide of at least one metal selected from the group consisting of Y, La, Ce, Ti, Zr and Al in some embodiments, and an oxide of at least one metal selected from the group consisting of Al, Ce, and Zr in some embodiments. The first metal oxide carrier may be an oxide containing zirconia (ZrO₂) as a main component, may be an Al—Zr-based composite oxide, which is a composite oxide containing zirconia and alumina (Al₂O₃) as main components, or may be an Al—Ce—Zr-based composite oxide, which is a composite oxide containing zirconia, alumina, and ceria (CeO₂) as main components. The zirconia may serve to maintain catalytic activity of the first Rh particles. The ceria may serve as an oxygen storage material which stores oxygen in an atmosphere under an oxygen excess atmosphere and discharges oxygen under an oxygen deficient atmosphere. In some embodiments, the first metal oxide carrier does not contain Ce because particle sizes of the Rh particles on the ceria are likely to increase under a high temperature environment. The alumina may serve to control diffusion of the first Rh particles. The first metal oxide carrier may be a composite oxide containing at least one of alumina, ceria, or zirconia as the main component(s), and further containing at least one of yttria (Y₂O₃), lanthana (La₂O₃), neodymia (Nd₂O₃), or praseodymia (Pr₆O₁₁). Yttria, lanthana, neodymia, and praseodymia improve heat resistance of the composite oxide.

Note that the phrase “contain as the main component(s)” herein means that the content of the referred component is 50 wt % or more of the total weight. When a plurality of main components are present, the phrase means that the sum of the contents of the components is 50 wt % or more. The content of the component described as the main component may be 70 wt % or more, 80 wt % or more, or 90 wt % or more of the total weight.

The first metal oxide carrier may be particulate, and may have any particle size according to the purpose.

The first Rh particles supported on the first metal oxide carrier function as a catalyst to remove harmful components contained in an exhaust gas and mainly function as a catalyst to reduce NOx. A mean of a particle size distribution of the first Rh particles may be within the range from 2 nm to 10 nm. Generally, the smaller the particle sizes of the Rh particles, the larger the specific surface area of the Rh particles, and therefore the higher the catalyst performance of the Rh particles. However, the Rh particle having an excessively small particle size tends to coarsen due to Ostwald ripening, aggregation, or the like in a high temperature environment, causing degradation of catalyst performance. When the mean of the particle size distribution of the first Rh particles is 2 nm or more, coarsening of the Rh particles in a high temperature environment is avoided or controlled, and therefore the deterioration of catalyst performance is avoided or controlled. When the mean of the particle size distribution of the first Rh particles is 10 nm or less, the first Rh particles have sufficiently large specific surface areas, and therefore the first Rh particles can provide high catalyst performance. The mean of the particle size distribution of the first Rh particles may be within the range from 3 nm to 6 nm, or 4 nm to 6 nm.

Additionally, the standard deviation of the particle size distribution of the first Rh particles may be 4 nm or less. When the standard deviation of the particle size distribution of the first Rh particles is 4 nm or less, there are few coarse particles and few fine particles that are likely to coarsen under a high temperature environment. Therefore, even after the first Rh particles are exposed to a high temperature environment, the first Rh particles can have the sufficiently large specific surface area, and as a result, the high catalyst performance can be provided.

The particle size distribution of the first Rh particles herein is a particle size distribution on the number basis (i.e., a number-weighted particle size distribution) determined by measuring a projected area equivalent circle diameter of 50 or more of the first Rh particles using an image obtained with a transmission electron microscope (TEM).

The amount of the supported first Rh particles, that is, the percentage of the first Rh particles based on the total weight of the first metal oxide carrier and the first Rh particles, may be within the range from 0.01 wt % to 5 wt %. The percentage of the first Rh particles of 0.01 wt % or more allows satisfactory removal of the harmful components from the exhaust gas by virtue of the sufficient amount of the first Rh particles present. The percentage of the first Rh particles of 5 wt % or less allows the amount of Rh used to be reduced, and additionally allows sufficient durability against a high temperature to be exhibited because coarsening of the first Rh particles under a high temperature environment is avoided or controlled owing to sufficient sparseness of the first Rh particles supported on the first metal oxide carrier.

The content of the first Rh particles in the first catalyst layer 20 may be, for example, from 0.05 g/L to 5 g/L, from 0.08 g/L to 2 g/L, or from 0.1 g/L to 1 g/L, based on the volume of the substrate in the first region X. This allows the exhaust gas purification device 100 to have a sufficiently high exhaust gas purification performance.

An amount of Rh dissolved into the first metal oxide carrier to form a solid solution based on the total weight of Rh contained in the first Rh-containing catalyst may be less than 17 wt %. This allows, as shown in Reference Examples described later, highly efficient removal of the harmful components even after the first Rh-containing catalyst is exposed to a high temperature environment. The amount of Rh dissolved into the first metal oxide carrier to form a solid solution based on the total weight of Rh contained in the first Rh-containing catalyst may be 3 wt % or less. In this case, as shown in Reference Examples described later, particularly highly efficient removal of the harmful components can be achieved even after the first Rh-containing catalyst is exposed to a high temperature environment.

The amount of Rh dissolved into the first metal oxide carrier to form a solid solution based on the total weight of Rh contained in the first Rh-containing catalyst can be determined as follows. An X-ray absorption spectrum Sm(x) of a standard sample of pure Rh metal and an X-ray absorption spectrum Sox(x) of a standard sample of Rh₂O₃ are measured with an X-ray absorption fine structure (XAFS) measurement device. The first Rh-containing catalyst is placed in a hydrogen atmosphere at 400° C. and an X-ray absorption spectrum S(x) at the K-absorption edge of Rh is measured with the XAFS measurement device. Using the obtained X-ray absorption spectra Sm(x), Sox(x), and S(x), least squares fitting is performed with the following formula:

$$S ( x ) = a \cdot Sm ( x ) + b \cdot Sox ( x )$$

using a and b as parameters, and the values of a and b are obtained. In a hydrogen atmosphere at 400° C., Rh present on the surface of the first metal oxide carrier (that is, Rh not dissolved into the first metal oxide carrier to form a solid solution) is reduced and present in a metal (zero-valent) state, while Rh dissolved into the first metal oxide carrier to form a solid solution is not reduced and present in an oxide (trivalent) state combined with oxygen in the first metal oxide carrier. Therefore, the ratio of a to b obtained by the least squares fitting corresponds to the ratio of the amount of Rh present on the surface of the first metal oxide carrier in the first Rh-containing catalyst to the amount of Rh dissolved into the first metal oxide carrier to form a solid solution. Therefore, the amount of Rh dissolved into the first metal oxide carrier to form a solid solution based on the total weight of Rh contained in the first Rh-containing catalyst can be obtained by calculating b/(a+b).

The first catalyst layer 20 further contains a first Ce-containing oxide. The first Ce-containing oxide serves as an oxygen storage material. The first Ce-containing oxide may be ceria or a composite oxide containing ceria (for example, a composite oxide containing ceria as a main component, a Ce—Zr-based composite oxide, which is a composite oxide containing ceria and zirconia as main components, or an Al—Ce—Zr-based composite oxide, which is a composite oxide containing alumina, ceria, and zirconia as main components). Especially, the Ce—Zr-based composite oxide may be used in some embodiments because the Ce—Zr-based composite oxide has high oxygen storage capacity and is relatively inexpensive. The Ce—Zr-based composite oxide may have a fluorite or pyrochlore crystalline structure, and the Ce—Zr-based composite oxide having the fluorite crystalline structure and the Ce—Zr-based composite oxide having the pyrochlore crystalline structure may be used in combination. In the fluorite-type Ce—Zr-based composite oxide, Ce ions and Zr ions are arranged on a fluorite-type ordered lattice. In the pyrochlore-type Ce—Zr-based composite oxide, Ce ions and Zr ions are arranged on a pyrochlore-type ordered lattice. In addition to the main component(s), the composite oxide containing ceria may further contain at least one of lanthana, yttria, neodymia, or praseodymia as an additive, and the additives may form a composite oxide together with the main component(s). The oxygen storage material may be particulate, and may have any particle size according to the purpose.

The Ce content (in terms of Ce atoms) in the first catalyst layer 20 may be, for example, more than 10 g/L and equal to or less than 25 g/L, or may be from 15 g/L to 25 g/L, based on the volume of the substrate in the first region X. This allows the exhaust gas purification device 100 to have a high OSC.

The first catalyst layer 20 may further contain any other component. Examples of the any other component include a binder and an additive.

### (3) Second Catalyst Layer 30

The second catalyst layer 30 is disposed on the substrate 10 and extends across a second region Y extending between the upstream end I and a second position Q, which is at a second distance Lb from the upstream end I toward the downstream end J (that is, in the flow direction of the exhaust gas). The second distance Lb may be from 40% to 70% of the total length Ls of the substrate 10. The length Ls of the substrate, the first distance La, and the second distance Lb may meet Ls≤La+Lb≤1.2 Ls. That is, a length of a region where the first catalyst layer 20 overlaps with the second catalyst layer 30 may be 0% or more and equal to or less than 20% of the total length Ls of the substrate 10. This allows the exhaust gas purification device 100 to have a high OSC. In the region where the first catalyst layer 20 overlaps with the second catalyst layer 30, the second catalyst layer 30 may be formed on the first catalyst layer 20 as shown in FIG. 1, or the first catalyst layer 20 may be formed on the second catalyst layer 30.

The second catalyst layer 30 contains second Rh particles. The second Rh particles may be supported on a second metal oxide carrier. That is, the second catalyst layer 30 may contain a second Rh-containing catalyst containing the second metal oxide carrier and the second Rh particles supported on the second metal oxide carrier.

Examples of the material that can be used as the second metal oxide carrier are the same as the examples of the materials that can be used as the first metal oxide carrier as listed above.

The second Rh particles function as a catalyst to remove harmful components contained in an exhaust gas and mainly function as a catalyst to reduce NOx. As described later, the second catalyst layer 30 contains Ce, which promotes coarsening of Rh particles under a high temperature environment, only in an amount equal to or less than the Ce content in the first catalyst layer 20, and therefore the second Rh particles are less likely to coarsen compared with the first Rh particles. Therefore, the mean of the particle size distribution of the second Rh particles is not specifically limited. From a perspective of ease of production, the mean of the particle size distribution of the second Rh particles may be within the range from 0.1 nm to 1 nm. From a perspective of further avoiding or controlling coarsening of the second Rh particles in a high temperature environment, the mean of the particle size distribution of the second Rh particles may be within the range from 2 nm to 10 nm. The standard deviation of the particle size distribution of the second Rh particles may be 4 nm or less, 1 nm or less, or 0.5 nm or less.

The particle size distribution of the second Rh particles herein is a particle size distribution on the number basis determined by measuring a projected area equivalent circle diameter of 50 or more of the second Rh particles using an image obtained with a transmission electron microscope (TEM).

The amount of the supported second Rh particles, that is, the percentage of the second Rh particles based on the total weight of the second metal oxide carrier and the second Rh particles, may be within the range from 0.01 wt % to 2 wt %. The percentage of the second Rh particles of 0.01 wt % or more allows satisfactory removal of the harmful components from the exhaust gas by virtue of the sufficient amount of the second Rh particles present. The percentage of the second Rh particles of 2 wt % or less allows the amount of Rh used to be reduced, and additionally allows sufficient durability against a high temperature to be exhibited because coarsening of the second Rh particles under a high temperature environment is avoided or controlled owing to sufficient sparseness of the second Rh particles supported on the second metal oxide carrier.

The content of the second Rh particles in the second catalyst layer 30 may be, for example, from 0.05 g/L to 5 g/L, from 0.08 g/L to 2 g/L, or from 0.1 g/L to 1 g/L, based on the volume of the substrate in the second region Y. This allows the exhaust gas purification device 100 to have a sufficiently high exhaust gas purification performance.

An amount of Rh dissolved into the second metal oxide carrier to form a solid solution, based on the total weight of Rh contained in the second Rh-containing catalyst, may be less than 17 wt %, or 3 wt % or less. A percentage of Rh dissolved into the second metal oxide carrier to form a solid solution can be obtained by a method similar to the method for determining the percentage of Rh dissolved into the first metal oxide carrier to form a solid solution described above.

The second catalyst layer 30 may optionally contain a second Ce-containing oxide. Examples of the material that can be used as the second Ce-containing oxide are the same as the examples of the materials that can be used as the first Ce-containing oxide as listed above.

The Ce content (in terms of Ce atoms) in the second catalyst layer 30 may be, for example, from 0 g/L to 20 g/L, or 5 g/L to 16 g/L, based on the volume of the substrate in the second region Y. The Ce content (in terms of Ce atoms) in the second catalyst layer 30 based on the volume of the substrate in the second region Y is equal to or less than the Ce content (in terms of Ce atoms) in the first catalyst layer 20 based on the volume of the substrate in the first region X. That is, the Ce content in the first catalyst layer 20 based on the volume of the substrate in the first region X is equal to or greater than the Ce content in the second catalyst layer 30 based on the volume of the substrate in the second region Y. When the first catalyst layer 20, which is positioned more downstream than the second catalyst layer 30 in the flow direction of the exhaust gas, contains the oxygen storage material at a higher concentration, the exhaust gas purification device 100 exhibits the improved OSC. The Ce content in the first catalyst layer 20 based on the volume of the substrate in the first region X may be one to nine times, two to nine times, or four to nine times the Ce content in the second catalyst layer 30 based on the volume of the substrate in the second region Y.

The second catalyst layer 30 may further contain any other component. Examples of the any other component include a binder and an additive.

### (4) Third Catalyst Layer 40

The third catalyst layer 40 is formed between the substrate 10 and the first catalyst layer 20 and between the substrate 10 and the second catalyst layer 30, in an entire region between the upstream end I and the downstream end J.

The third catalyst layer 40 contains Pd particles. The Pd particles function as a catalyst to remove harmful components contained in an exhaust gas, and mainly function as a catalyst to oxidize HC.

The content of the Pd particles in the third catalyst layer 40 may be, for example, from 0.1 g/L to 10 g/L, from 1 g/L to 5 g/L, or from 1 g/L to 3 g/L, based on the total volume of the substrate. This allows the exhaust gas purification device 100 to have a sufficiently high exhaust gas purification performance.

The third catalyst layer 40 may further contain another component, such as a carrier to support the Pd particles, an oxygen storage material, and a barium compound.

As the carrier of the Pd particles, for example, the metal oxide carrier can be used. The Pd particles can be supported on the carrier by any method, such as an impregnation supporting method, an adsorption supporting method, and a water-absorption supporting method.

Examples of the material that can be used as the metal oxide carrier are the same as the examples of the materials that can be used as the first metal oxide carrier as listed above.

Examples of the material that can be used as the oxygen storage material are the same as the examples of the materials that can be used as the first Ce-containing oxide as listed above.

The barium compound can prevent or control poisoning of the Pd particles. Examples of the barium compound include barium sulfate, barium carbonate, barium oxide, and barium nitrate. The barium compound may be particulate, and may have any particle size according to the purpose.

The third catalyst layer 40 may further contain any other component. Examples of the any other component include a binder and an additive.

The exhaust gas purification device according to the embodiment may be applicable to various kinds of vehicles including internal combustion engines. The exhaust gas purification device according to the embodiment can be used as a start-up converter (S/C) disposed immediately downstream of the internal combustion engine in a flow direction of an exhaust gas or as an underfloor converter (UF/C) disposed downstream of the S/C in the flow direction of the exhaust gas.

### II. Method for Manufacturing Exhaust Gas Purification Device

An example of the method for manufacturing the exhaust gas purification device 100 according to the embodiment is described. The method for manufacturing the exhaust gas purification device 100 includes preparing the first Rh-containing catalyst, preparing the second Rh-containing catalyst, forming the third catalyst layer 40 in the entire region of the substrate 10, forming the first catalyst layer 20 in the first region X of the substrate 10, and forming the second catalyst layer 30 in the second region Y of the substrate 10. The first catalyst layer 20 and the second catalyst layer 30 may be formed in any order. Preparing the second Rh-containing catalyst and forming the third catalyst layer 40 are not essential steps.

### (a) Preparation of First Rh-Containing Catalyst

The first Rh-containing catalyst can be prepared by the following steps: impregnating the first metal oxide carrier with a first Rh compound solution; drying the first metal oxide carrier impregnated with the first Rh compound solution to obtain a first Rh-supporting metal oxide; and heating the first Rh-supporting metal oxide to a temperature within the range from 850° C. to 1000° C. in an atmosphere containing carbon monoxide (CO) at a concentration of 0.01 vol % to 5 vol % with the balance being an inert gas to obtain the first Rh-containing catalyst.

Examples of the first Rh compound solution include an aqueous solution of rhodium hydroxide and an aqueous solution of rhodium nitrate. The impregnation method is not specifically limited. For example, the first metal oxide carrier and the first Rh compound solution are added to distilled water being stirred to allow the first metal oxide carrier to be impregnated with the first Rh compound solution.

Next, the first metal oxide carrier impregnated with the first Rh compound solution is dried to obtain the first Rh-supporting metal oxide. Baking may be performed after drying as appropriate.

The first Rh-supporting metal oxide is heated to the temperature within the range from 850° C. to 1000° C. in an atmosphere containing carbon monoxide (CO) at a concentration of 0.01 vol % to 5 vol % with the balance being an inert gas. Thus, the first Rh-containing catalyst containing the first metal oxide carrier and the first Rh particles supported on the first metal oxide carrier is obtained.

Examples of the inert gas include nitrogen and argon. The heating period may be any appropriate length of time, and, for example, may be from 1 to 30 hours. Heating in the atmosphere containing CO and the inert gas allows appropriate control of the particle size distribution of the first Rh particles while avoiding or reducing dissolution of Rh into the first metal oxide carrier to form a solid solution. For example, the mean of the particle size distribution of the first Rh particles can be controlled to be within the range from 2 nm to 10 nm, from 3 nm to 6 nm, or 4 nm to 6 nm, and the standard deviation of the particle size distribution of the first Rh particles can be controlled to be 4 nm or less.

Heating in an inert atmosphere, such as a nitrogen atmosphere, or an oxidation atmosphere, such as an air atmosphere, causes dissolution of Rh into the first metal oxide carrier to form a solid solution, which decreases the first Rh particles on the surface of the first metal oxide carrier, and therefore it is difficult to provide a high catalyst performance.

### (b) Preparation of Second Rh-Containing Catalyst

The second Rh-containing catalyst can be prepared by the following steps: impregnating the second metal oxide carrier with a second Rh compound solution; and drying the second metal oxide carrier impregnated with the second Rh compound solution. Baking may be performed after drying as appropriate. Heating at a temperature within the range from 850° C. to 1000° C. in an atmosphere containing CO at a concentration of 0.01 vol % to 5 vol % with the balance being an inert gas may be performed after the drying and the optional baking, but the heating is not essential. That is, the second Rh-containing catalyst can be prepared similarly to the first Rh-containing catalyst except that heating in the atmosphere containing CO and the inert gas is not essential.

### (c) Formation of Third Catalyst Layer

The third catalyst layer 40 containing Pd particles is formed in the entire region of the substrate 10. The third catalyst layer 40 can be formed as follows, for example. First, a third slurry, which is a slurry containing a Pd particle precursor is prepared. As the Pd particle precursor, for example, an appropriate Pd salt of inorganic acid, such as hydrochloride, nitrate, phosphate, sulfate, borate, and hydrofluoride can be used. Alternatively, the third slurry may contain carrier powder on which the Pd particles are supported in advance. The third slurry may further contain any component, such as an oxygen storage material, a binder, or an additive. Properties of the third slurry, such as viscosity and a particle diameter of a solid component, may be adjusted as appropriate. The prepared third slurry is applied over the entire region of the substrate 10. For example, the entire region of the substrate 10 is immersed in the third slurry, and after a predetermined period has passed, the substrate 10 is taken out of the third slurry, thus allowing the third slurry to be applied over the entire region of the substrate 10. Alternatively, the third slurry may be poured from the upstream end I into the substrate 10, and blown with a blower from the upstream end I to be spread toward the downstream end J, thereby allowing the entire region of the substrate 10 to be coated with the third slurry. Next, the third slurry is dried and baked at a predetermined temperature for a predetermined period. Thus, the third catalyst layer 40 is formed in the entire region of the substrate 10.

### (d) Formation of First Catalyst Layer

The first catalyst layer 20 containing the first Rh-containing catalyst and the first Ce-containing oxide is formed in the first region X of the substrate 10. For example, the first catalyst layer 20 can be formed as follows. First, a first slurry containing the first Rh-containing catalyst and the first Ce-containing oxide is prepared. The first slurry may further contain any component, such as a binder or an additive. Properties of the first slurry, such as viscosity and a particle diameter of a solid component, may be adjusted as appropriate. The prepared first slurry is applied over the first region X of the substrate 10. For example, the first region X of the substrate 10 is immersed in the first slurry, and after a predetermined period has passed, the substrate 10 is taken out of the first slurry, thus allowing the first slurry to be applied over the first region X of the substrate 10. Alternatively, the first slurry may be poured from the downstream end J into the substrate 10, and blown with a blower from the downstream end J to be spread toward the upstream end I, thereby allowing the first region X of the substrate 10 to be coated with the first slurry. Next, the first slurry is dried and baked at a predetermined temperature for a predetermined period. Thus, the first catalyst layer 20 is formed in the first region X of the substrate 10.

### (e) Formation of Second Catalyst Layer

The second catalyst layer 30 containing the second Rh particles is formed in the second region Y of the substrate 10. The second catalyst layer 30 can be formed as follows, for example. First, a second slurry containing the second Rh-containing catalyst or an Rh particle precursor is prepared. As the Rh particle precursor, for example, an appropriate Rh salt of inorganic acid, such as hydrochloride, nitrate, phosphate, sulfate, borate, and hydrofluoride can be used. The second slurry may further contain any component, such as an oxygen storage material, a binder, or an additive. Properties of the second slurry, such as viscosity and a particle diameter of a solid component, may be adjusted as appropriate. The prepared second slurry is applied over the second region Y of the substrate 10. For example, the second region Y of the substrate 10 is immersed in the second slurry, and after a predetermined period has passed, the substrate 10 is taken out of the second slurry, thus allowing the second slurry to be applied over the second region Y of the substrate 10. Alternatively, the second slurry may be poured from the upstream end I into the substrate 10, and blown with a blower from the upstream end I to be spread toward the downstream end J, thereby allowing the second region Y of the substrate 10 to be coated with the second slurry. Next, the second slurry is dried and baked at a predetermined temperature for a predetermined period. Thus, the second catalyst layer 30 is formed in the second region Y of the substrate 10.

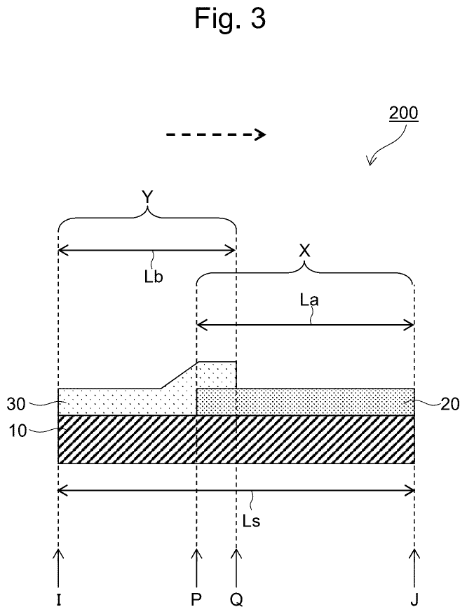

While the embodiments of the present disclosure have been described in detail above, the present disclosure is not limited to the above-described embodiments, and can be subjected to various kinds of changes in design without departing from the scope of the claims. For example, the exhaust gas purification device need not include the third catalyst layer 40 described above. That is, an exhaust gas purification device 200 not including the third catalyst layer 40 as illustrated in FIG. 3 is also within the scope of the present disclosure.

### EXAMPLES

The following specifically describes the present disclosure with the examples, but the present disclosure is not limited to the examples.

### (1) Materials Used in Examples and Comparative Examples

a) Substrate (honeycomb substrate)
Material: cordierite
Volume: 875 cc
Length: 10.5 cm
Thickness of partition wall: 2 mil (50.8 μm)
Cell density: 600 pieces per square inch
Cross-sectional shape of cell: hexagonal shape

### b) AZ Particles

The AZ particles were composite oxide particles containing Al₂O₃ and ZrO₂ as main components and further containing La₂O₃ and Y₂O₃. Weight fractions of the respective components in the AZ particles were Al₂O₃: 30 wt %, ZrO₂: 60 wt %, La₂O₃: 5 wt %, and Y₂O₃: 5 wt %.

c) Al₂O₃Particles

The Al₂O₃ particles were composite oxide particles containing Al₂O₃ as a main component and further containing La₂O₃. Weight fractions of the respective components in the Al₂O₃ particles were Al₂O₃: 99 wt % and La₂O₃: 1 wt %.

### d) ACZ Particles

The ACZ particles were composite oxide particles containing Al₂O₃, CeO₂, and ZrO₂ as main components and further containing La₂O₃ and Y₂O₃. Weight fractions of the respective components in the ACZ particles were Al₂O₃: 30 wt %, CeO₂: 20 wt %, ZrO₂: 40 wt %, La₂O₃: 5 wt %, and Y₂O₃: 5 wt %.

### e) Fluorite ZC Particles

The fluorite ZC particles were composite oxide particles containing CeO₂ and ZrO₂ as main components and further containing La₂O₃ and Y₂O₃. Weight fractions of the respective components in the fluorite ZC particles were CeO₂: 20 wt %, ZrO₂: 70 wt %, La₂O₃: 5 wt %, and Y₂O₃: 5 wt %.

### f) Pyrochlore CZ Particles

The pyrochlore CZ particles were composite oxide particles containing CeO₂ and ZrO₂ as main components and further containing Pr₆O₁₁. Weight fractions of the respective components in the pyrochlore CZ particles were CeO₂: 51.7 wt %, ZrO₂: 46.6 wt %, and Pr₆O₁₁: 1.7 wt %.

### g) Aqueous Solution of Rhodium Nitrate

### h) Aqueous Solution of Rhodium Hydroxide

### i) Aqueous Solution of Palladium Nitrate

### j) Barium Sulfate Particles

### (2) Manufacturing Exhaust Gas Purification Device

### Examples 1 to 3

### a) Preparation of First Rh-Containing Catalyst

The AZ particles and the aqueous solution of rhodium nitrate were added in this order to distilled water being stirred. The obtained mixture was dried, and then baked by heating it in an electric furnace in an air atmosphere at 500° C. for two hours. Thus, the first Rh-supporting metal oxide was obtained. The first Rh-supporting metal oxide was heated in an atmosphere containing CO at a concentration of 1 vol % with the balance being N₂ at 950° C. for 20 hours. Thus, the first Rh-containing catalyst was obtained.

The first Rh-containing catalyst was observed with a transmission electron microscope (TEM) to determine the particle size distribution (initial particle size distribution) of the Rh particles (first Rh particles) supported on the AZ particles. Table 1-1 shows the mean and the standard deviation of the initial particle size distribution of the first Rh particles.

A percentage of Rh dissolved into the AZ particles to form a solid solution based on the total weight of Rh contained in the first Rh-containing catalyst was obtained by measuring the X-ray absorption spectrum at the K-absorption edge of Rh with an XAFS measurement device. Table 1-1 shows the results.

### b) Preparation of Second Rh-Containing Catalyst

The AZ particles and the aqueous solution of rhodium nitrate were added in this order to distilled water being stirred. The obtained mixture was dried, and baked by heating it in an electric furnace in an air atmosphere at 500° C. for two hours. Thus, the second Rh-containing catalyst containing the AZ particles and the Rh particles supported on the AZ particles was obtained.

### c) Preparation of Slurry

The first Rh-containing catalyst, the Al₂O₃ particles, the fluorite ZC particles, the pyrochlore CZ particles, and an Al₂O₃-based binder were added to distilled water being stirred to prepare a suspended first slurry. The second Rh-containing catalyst, the Al₂O₃ particles, the fluorite ZC particles, the pyrochlore CZ particles, and an Al₂O₃-based binder were added to distilled water being stirred to prepare a suspended second slurry. The Al₂O₃ particles, the ACZ particles, the aqueous solution of palladium nitrate, the barium sulfate particles, and an Al₂O₃-based binder were added to distilled water being stirred to prepare a suspended third slurry.

### d) Formation of Third Catalyst Layer

The third slurry was poured from the upstream end of the substrate, and an excess amount of the third slurry was blown off by a blower. Thus, the partition walls of the substrate were coated with the third slurry over the entire region between the upstream end and the downstream end of the substrate, thereby forming a third slurry layer. The substrate was placed in a dryer with the internal temperature held at 120° C. for two hours to vaporize the water in the third slurry layer. Next, baking was performed in an electric furnace in an air atmosphere at 500° C. for two hours. Thus, the third catalyst layer was formed.

The contents of the Al₂O₃ particles, the ACZ particles, the Pd particles derived from the aqueous solution of palladium nitrate, and the barium sulfate particles in the third catalyst layer were 10 g/L, 15 g/L, 2 g/L, and 5 g/L, respectively, based on the total volume of the substrate.

### e) Formation of First Catalyst Layer

The first slurry was poured from the downstream end of the substrate, and an excess amount of the first slurry was blown off by a blower. Thus, the third catalyst layer was coated with the first slurry over a first region between the downstream end of the substrate and a first position which was distant from the downstream end toward the upstream end of the substrate by 50% of the total length of the substrate, thereby forming a first slurry layer. The substrate was placed in a dryer with the internal temperature held at 120° C. for two hours to vaporize the water in the first slurry layer. Next, baking was performed in an electric furnace in an air atmosphere at 500° C. for two hours. Thus, the first catalyst layer was formed.

The contents of Rh, the AZ particles, the Al₂O₃ particles, the fluorite ZC particles, and the pyrochlore CZ particles in the first catalyst layer were as shown in Table 1-1. The content of each material listed in Table 1-1 is based on the volume of the substrate in the first region.

### f) Formation of Second Catalyst Layer

The second slurry was poured from the upstream end of the substrate, and an excess amount of the second slurry was blown off by a blower. Thus, the third catalyst layer was coated with the second slurry over a second region between the upstream end of the substrate and a second position which was distant from the upstream end toward the downstream end of the substrate by 50% of the total length of the substrate, thereby forming a second slurry layer. The substrate was placed in a dryer with the internal temperature held at 120° C. for two hours to vaporize the water in the second slurry layer. Next, baking was performed in an electric furnace in an air atmosphere at 500° C. for two hours. Thus, the second catalyst layer was formed.

The contents of Rh, the AZ particles, the Al₂O₃ particles, the fluorite ZC particles, and the pyrochlore CZ particles in the second catalyst layer were as shown in Table 1-2. The content of each material listed in Table 1-2 is based on the volume of the substrate in the second region.

Thus, exhaust gas purification devices of Examples 1 to 3 were obtained. The ratio (Ce content ratio) of the Ce content in the first catalyst layer based on the volume of the substrate in the first region to the Ce content in the second catalyst layer based on the volume of the substrate in the second region was as shown in Table 1-2.

### Comparative Example 1

An exhaust gas purification device of Comparative Example 1 was obtained similarly to Example 1, except that the contents of Rh, the AZ particles, the Al₂O₃ particles, the fluorite ZC particles, and the pyrochlore CZ particles in the first catalyst layer and the contents of Rh, the AZ particles, the Al₂O₃ particles, the fluorite ZC particles, and the pyrochlore CZ particles in the second catalyst layer were as described in Tables 1-1 and 1-2.

### Example 4

An exhaust gas purification device of Example 4 was obtained similarly to Example 2, except that the second Rh-containing catalyst was prepared as follows.

### Preparation of Second Rh-Containing Catalyst

The AZ particles and the aqueous solution of rhodium nitrate were added in this order to distilled water being stirred. The obtained mixture was dried, and baked by heating it in an electric furnace in an air atmosphere at 500° C. for two hours. Thus, a second Rh-supporting metal oxide was obtained. The second Rh-supporting metal oxide was heated in an atmosphere containing CO at a concentration of 1 vol % with the balance being N₂ at 950° C. for 20 hours. Thus, the second Rh-containing catalyst was obtained.

### Comparative Examples 2 to 5

Exhaust gas purification devices of Comparative Examples 2 to 5 were obtained similarly to Examples 1 to 3 and Comparative Example 1, except that the first Rh-containing catalyst was prepared as follows.

### Preparation of First Rh-Containing Catalyst

The AZ particles and the aqueous solution of rhodium hydroxide were added in this order to distilled water being stirred. The obtained mixture was dried, and then baked by heating it in an electric furnace in an air atmosphere at 500° C. for two hours. Thus, the first Rh-supporting metal oxide was obtained. The first Rh-supporting metal oxide was heated in a nitrogen atmosphere at 850° C. for five hours. Thus, the first Rh-containing catalyst was obtained.

The first Rh-containing catalyst was observed with a transmission electron microscope (TEM) to determine the particle size distribution (initial particle size distribution) of the Rh particles (first Rh particles) supported on the AZ particles. Table 1-1 shows the mean and the standard deviation of the initial particle size distribution of the first Rh particles.

A percentage of Rh dissolved into the AZ particles to form a solid solution based on the total weight of Rh contained in the first Rh-containing catalyst was determined similarly to Examples 1 to 3. Table 1-1 shows the results.

### Comparative Example 6

An exhaust gas purification device of Comparative Example 6 was obtained similarly to Comparative Example 3, except that the second Rh-containing catalyst was prepared as follows.

### Preparation of Second Rh-Containing Catalyst

The AZ particles and the aqueous solution of rhodium hydroxide were added in this order to distilled water being stirred. The obtained mixture was dried, and then baked by heating it in an electric furnace in an air atmosphere at 500° C. for two hours. Thus, the second Rh-supporting metal oxide was obtained. The second Rh-supporting metal oxide was heated in a nitrogen atmosphere at 850° C. for five hours. Thus, the second Rh-containing catalyst was obtained.

### Comparative Example 7

An exhaust gas purification device of Comparative Example 7 was obtained similarly to Example 3, except that the first Rh-containing catalyst was prepared as follows.

### Preparation of First Rh-Containing Catalyst

The AZ particles and the aqueous solution of rhodium nitrate were added in this order to distilled water being stirred. The obtained mixture was dried, and baked by heating it in an electric furnace in an air atmosphere at 500° C. for two hours. Thus, the first Rh-containing catalyst containing the AZ particles and the Rh particles supported on the AZ particles was obtained.

The first Rh-containing catalyst was observed with a transmission electron microscope (TEM) to determine the particle size distribution (initial particle size distribution) of the Rh particles (first Rh particles) supported on the AZ particles. Table 1-1 shows the mean and the standard deviation of the initial particle size distribution of the first Rh particles.

A percentage of Rh dissolved into the AZ particles to form a solid solution based on the total weight of Rh contained in the first Rh-containing catalyst was determined similarly to Examples 1 to 3. Table 1-1 shows the results.

### (3) Aging Treatment

Each of the exhaust gas purification devices was connected to an exhaust system of a V8 engine, a stoichiometric air-fuel mixture (air-fuel ratio A/F=14.6) and a lean air-fuel mixture containing excess oxygen (A/F>14.6) were alternately introduced into the engine with a time ratio of 3:1 at a fixed cycle of time, and a bed temperature of the exhaust gas purification device was maintained at 950° C. for 50 hours. Thus, the exhaust gas purification devices were aged.

### (4) OSC Evaluation

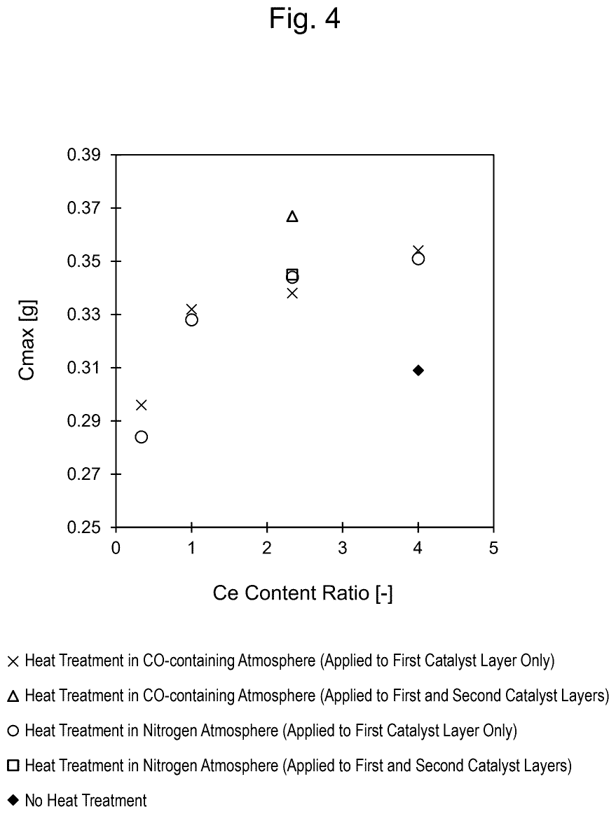

The exhaust gas purification device which had been aged was connected to an exhaust system of an L4 engine, and an air-fuel mixture with an air-fuel ratio A/F of 14.1 and an air-fuel mixture with an air-fuel ratio A/F of 15.1 were alternately supplied to the engine. An exhaust gas at a temperature of 600° C. was introduced into the exhaust gas purification device. Excess or deficiency in oxygen was calculated based on a difference between the stoichiometric point and the A/F sensor output by 0.23×ΔA/F×ejected fuel amount. Thus, the maximum oxygen storage amount (Cmax) was determined. Table 1-2 and FIG. 4 show the results. The Cmax was high when the Ce content ratio was 1 or more. That is, the OSC was high when the Ce content ratio was 1 or more.

### (5) NOx Removal Performance Evaluation

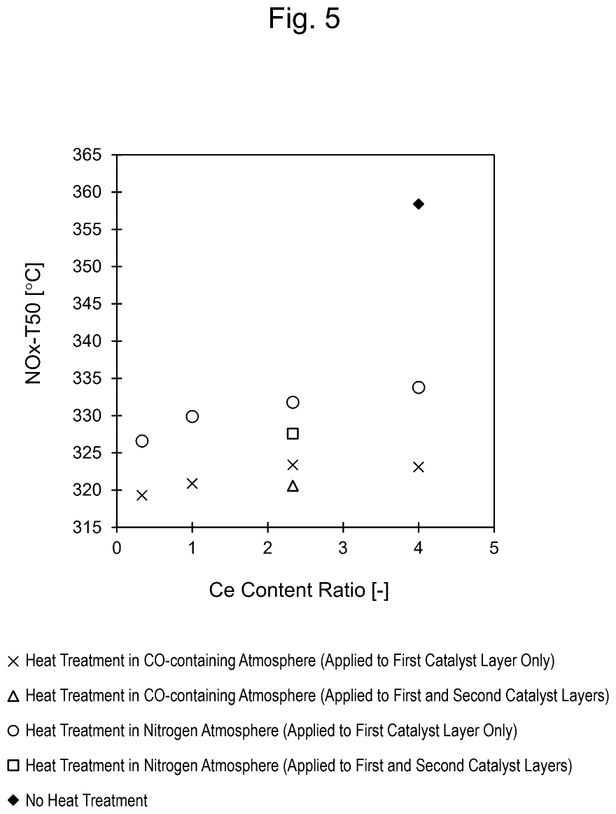

The exhaust gas purification device which had been aged was connected to an exhaust system of an L4 engine, an air-fuel mixture with an air-fuel ratio A/F of 14.4 was supplied to the engine at an air flow rate of 30 g/s, the bed temperature of the exhaust gas purification device was increased from 200° C. to 500° C. at a rate of 20° C./minute, and the bed temperature when 50% of NOx in the gas was removed (which is hereinafter referred to as “NOx-T50” as appropriate) was measured. Table 1-2 and FIG. 5 show the results.

The exhaust gas purification devices (Examples 1 to 4 and Comparative Example 1) using the first Rh-containing catalyst prepared by the heating treatment in a CO-containing atmosphere exhibited the lower NOx-T50s than those of the exhaust gas purification devices (Comparative Examples 2 to 6) using the first Rh-containing catalyst prepared by the heating treatment in a nitrogen atmosphere and the exhaust gas purification device (Comparative Example 7) using the first Rh-containing catalyst prepared without a heating treatment. From this fact, it is understood that an NOx reducing performance was improved by the first Rh-containing catalyst prepared by the heating treatment in the CO-containing atmosphere. It is considered that since the mean of the particle size distribution of the initial Rh particles was as large as 4.68 nm to 5.75 nm in the first Rh-containing catalyst prepared by the heating treatment in the CO-containing atmosphere, coarsening of the Rh particles was avoided or controlled during the aging treatment, which in turn avoided or controlled a decrease in the specific surface area of the Rh particles, resulting in a high NOx reducing performance. It is considered that since the mean of the particle size distribution of the Rh particles was as small as 0.7 nm in the first Rh-containing catalyst prepared without the heating treatment, coarsening of the Rh particles was caused during the aging treatment, which in turn decreased the specific surface area of the Rh particles, resulting in the low NOx reducing performance. In the first Rh-containing catalyst prepared by the heating treatment in a nitrogen atmosphere, 17.1 wt % or more of Rh contained in the first Rh-containing catalyst was dissolved into the AZ particles to form a solid solution, which is considered to be the cause of the low NOx reducing performance.

The exhaust gas purification device of Example 4 using the second Rh-containing catalyst prepared by the heating treatment in the CO-containing atmosphere exhibited the lower NOx-T50 than that of the exhaust gas purification device of Example 2 using the second Rh-containing catalyst prepared without the heating treatment. From this fact, it is understood that the NOx reducing performance was improved by the second Rh-containing catalyst prepared by the heating treatment in the CO-containing atmosphere. However, an improvement in the NOx reducing performance by the first Rh-containing catalyst prepared by the heating treatment in the CO-containing atmosphere was much larger than an improvement in the NOx reducing performance by the second Rh-containing catalyst prepared by the heating treatment in the CO-containing atmosphere. Therefore, it is understood that preparing the first Rh-containing catalyst by the heating treatment in the CO-containing atmosphere is particularly effective.

TABLE 1-1

| | First Catalyst Layer | | | | | | | | |
|---|---|---|---|---|---|---|---|---|---|
| | | Percentage | Rh Particle Size | | | | | | |
| | Heating | of dissolved | | Standard | Content [g/L] | | | | |
| | Treatment | Rh | Mean | Deviation | | AZ | Al₂O₃ | f-ZC | p-CZ |
| | Atmosphere | [wt %] | [nm] | [nm] | Rh | Particles | Particles | Particles | Particles |
| Example 1 | CO + N₂ | 0 | 5.66 | 3.61 | 0.48 | 30 | 30 | 50 | 10 |
| Example 2 | CO + N₂ | 0 | 5.75 | 2.99 | 0.48 | 18 | 18 | 70 | 14 |
| Example 3 | CO + N₂ | 0 | 4.82 | 2.55 | 0.48 | 12 | 12 | 80 | 16 |
| Comparative | CO + N₂ | 0 | 4.68 | 2.29 | 0.48 | 45 | 45 | 25 | 5 |
| Example 1 | | | | | | | | | |
| Example 4 | CO + N₂ | 0 | 5.75 | 2.99 | 0.48 | 18 | 18 | 70 | 14 |
| Comparative | N₂ | 17.6 | 5.03 | 1.65 | 0.48 | 30 | 30 | 50 | 10 |
| Example 2 | | | | | | | | | |
| Comparative | N₂ | 18.2 | 4.59 | 1.59 | 0.48 | 18 | 18 | 70 | 14 |
| Example 3 | | | | | | | | | |
| Comparative | N₂ | 17.5 | 5.10 | 1.71 | 0.48 | 12 | 12 | 80 | 16 |
| Example 4 | | | | | | | | | |
| Comparative | N₂ | 17.1 | 5.78 | 1.92 | 0.48 | 45 | 45 | 25 | 5 |
| Example 5 | | | | | | | | | |
| Comparative | N₂ | 18.2 | 4.59 | 1.59 | 0.48 | 18 | 18 | 70 | 14 |
| Example 6 | | | | | | | | | |
| Comparative | No Heating | 0 | 0.7 | 0.23 | 0.48 | 12 | 12 | 80 | 16 |
| Example 7 | Treatment | | | | | | | | |

f-ZC Particles: Fluorite ZC Particles
p-CZ Particles: Pyrochlore CZ Particles

TABLE 1-2

| | Second Catalyst Layer | | | | | | Ce | | |
|---|---|---|---|---|---|---|---|---|---|
| | Heating | Content [g/L] | | | | | Content | | |
| | Treatment | | AZ | Al₂O₃ | f-ZC | p-CZ | Ratio | OSC | NOx-T50 |
| | Atmosphere | Rh | Particles | Particles | Particles | Particles | [—] | [g] | [° C.] |
| Example 1 | No Heating | 0.16 | 30 | 30 | 50 | 10 | 1 | 0.332 | 320.9 |
| | Treatment | | | | | | | | |
| Example 2 | No Heating | 0.16 | 42 | 42 | 30 | 6 | 2.3 | 0.338 | 323.4 |
| | Treatment | | | | | | | | |
| Example 3 | No Heating | 0.16 | 48 | 48 | 20 | 4 | 4 | 0.354 | 323.1 |
| | Treatment | | | | | | | | |
| Comparative | No Heating | 0.16 | 15 | 15 | 75 | 15 | 0.3 | 0.296 | 319.3 |
| Example 1 | Treatment | | | | | | | | |
| Example 4 | CO + N₂ | 0.16 | 42 | 42 | 30 | 6 | 2.3 | 0.367 | 320.6 |
| Comparative | No Heating | 0.16 | 30 | 30 | 50 | 10 | 1 | 0.328 | 329.9 |
| Example 2 | Treatment | | | | | | | | |
| Comparative | No Heating | 0.16 | 42 | 42 | 30 | 6 | 2.3 | 0.344 | 331.8 |
| Example 3 | Treatment | | | | | | | | |
| Comparative | No Heating | 0.16 | 48 | 48 | 20 | 4 | 4 | 0.351 | 333.8 |
| Example 4 | Treatment | | | | | | | | |
| Comparative | No Heating | 0.16 | 15 | 15 | 75 | 15 | 0.3 | 0.284 | 326.6 |
| Example 5 | Treatment | | | | | | | | |
| Comparative | N₂ | 0.16 | 42 | 42 | 30 | 6 | 2.3 | 0.345 | 327.6 |
| Example 6 | | | | | | | | | |
| Comparative | No Heating | 0.16 | 48 | 48 | 20 | 4 | 4 | 0.309 | 358.4 |
| Example 7 | Treatment | | | | | | | | |

f-ZC Particles: Fluorite ZC Particles
p-CZ Particles: Pyrochlore CZ Particles

### Reference Examples 1 to 6

In Reference Examples 1 to 6, experiments were conducted to investigate an effect of the percentage of Rh dissolved into the AZ particles to form a solid solution on the NOx reducing performance.

### (1) Production of Exhaust Gas Purification Material

As the metal oxide carrier, composite oxide particles containing Al₂O₃ and ZrO₂ as main components and further containing La₂O₃, Y₂O₃, and Nd₂O₃ (which are referred to as “AZ particle” as appropriate in Reference Examples, and weight fractions of the respective components in the AZ particles were Al₂O₃: 30 wt %, ZrO₂: 60 wt %, La₂O₃: 4 wt %, Y₂O₃: 4 wt %, and Nd₂O₃: 2 wt %) were prepared.

6 g of the AZ particles and 4 g of the aqueous solution of rhodium hydroxide (Rh concentration: 1 wt %) were added in this order to distilled water being stirred, and they were stirred for 10 minutes. The obtained mixture was dried, and baked by heating it in an electric furnace in an air atmosphere at 500° C. for two hours. Thus, a Rh-supporting metal oxide a was obtained.

The Rh-supporting metal oxide a was heated in an atmosphere containing CO at a concentration of 1 vol % with the balance being N₂ at 850° C. for five hours. Thus, an exhaust gas purification material a was obtained.

6 g of the AZ particles and 1.45 g of the aqueous solution of rhodium nitrate (Rh concentration: 2.75 wt %) were added in this order to distilled water being stirred, and they were stirred for 10 minutes. The obtained mixture was dried, and baked by heating it in an electric furnace in an air atmosphere at 500° C. for two hours. Thus, a Rh-supporting metal oxide b was obtained.

The Rh-supporting metal oxide b was heated in an air atmosphere at 1000° C. for five hours. Thus, an exhaust gas purification material b was obtained.

The exhaust gas purification material a and the exhaust gas purification material b by amounts described in Table 2 were mixed to obtain an exhaust gas purification material. A percentage of Rh dissolved into the AZ particles to form a solid solution based on the total weight of Rh contained the exhaust gas purification material was determined by measuring the X-ray absorption spectrum at the K-absorption edge of Rh with an XAFS measurement device. Table 2 shows the results.

### (2) Production of Pellet for Exhaust Gas Purification Performance Evaluation

To distilled water being stirred, 6 g of the exhaust gas purification material, 4 g of composite oxide particles containing CeO₂ and ZrO₂ as main components and further containing Pr₆O₁₁ (which are referred to as “CZ particle” as appropriate in Reference Examples, and weight fractions of the respective components in the CZ particles were CeO₂: 51.4 wt %, ZrO₂: 45.6 wt %, and Pr₆O₁₁: 3.0 wt %), and 10 g of composite oxide particles containing Al₂O₃, CeO₂, and ZrO₂ as main components and further containing La₂O₃, Y₂O₃, and Nd₂O₃ (which are referred to as “ACZ particle” as appropriate in Reference Examples, and weight fractions of the respective components in the ACZ particles were Al₂O₃: 30 wt %, CeO₂: 20 wt %, ZrO₂: 44 wt %, La₂O₃: 2 wt %, Y₂O₃: 2 wt %, and Nd₂O₃: 2 wt %) were added. Hydroxyethyl cellulose (HEC) and citric acid were further added to adjust the viscosity, and they were stirred for six hours to obtain a slurry. The slurry was baked by heating it in an electric furnace in an air atmosphere at 500° C. for two hours. The obtained baked body was pulverized to a predetermined size to obtain a pellet.

### (3) Aging Treatment of Pellet

While heated to 1000° C., the pellet was exposed alternately to a rich air-fuel mixture (air-fuel ratio A/F<14.6) containing excess fuel and a lean air-fuel mixture containing excess oxygen (A/F>14.6) every five minutes for five hours.

(4) Exhaust Gas Purification Performance Evaluation after Aging Treatment

While the gas having the composition described in Table 3 was allowed to flow to the pellet after the aging treatment at the flow rate of 15 L/minute, the pellet was heated to 600° C. and maintained for five minutes and then the pellet was allowed to be cooled down to 150° C. Afterwards, while the flow of the gas was continued, the temperature of the pellet was increased up to 600° C. at a rate of 20° C./minute, and a temperature of the pellet when 50% of NOx in the gas was removed (which is hereinafter referred to as “NOx-T50” as appropriate) was measured. The results were as shown in Table 2.

TABLE 2

| | Amount of | Amount of | | |
|---|---|---|---|---|
| | Exhaust Gas | Exhaust Gas | | |
| | Purification | Purification | Percentage of | |
| | Material a | Material b | dissolved Rh | NOx-T50 |
| | [g] | [g] | [wt %] | [° C.] |
| Reference Example 1 | 6.0 | 0.0 | 0 | 287.8 |
| Reference Example 2 | 5.7 | 0.3 | 3 | 288.4 |
| Reference Example 3 | 5.4 | 0.6 | 5.9 | 293.8 |
| Reference Example 4 | 4.8 | 1.2 | 11.7 | 300.0 |
| Reference Example 5 | 4.2 | 1.8 | 17.6 | 305.0 |
| Reference Example 6 | 3.6 | 2.4 | 35.2 | 320.3 |

TABLE 3

| Component | Concentration | |
|---|---|---|
| CO | 0.52 | vol % |
| O₂ | 0.50 | vol % |
| C₃H₆ | 3000 | ppmC |
| NO | 0.32 | vol % |
| CO₂ | 14 | vol % |
| H₂ | 3 | vol % |

| | |
|---|---|
| N₂ | Balance |

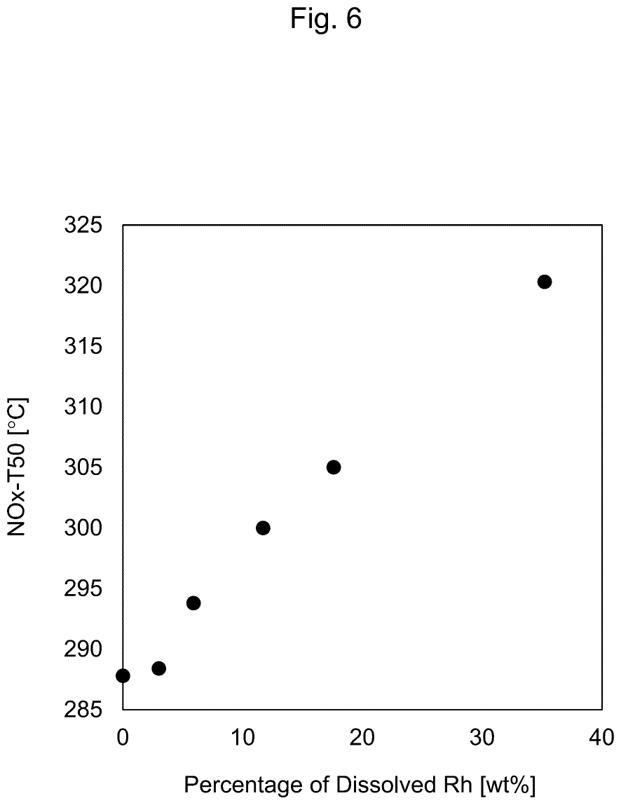

FIG. 6 shows the relationship between the percentage of dissolved Rh forming a solid solution and NOx-T50. FIG. 6 shows that the smaller the percentage of dissolved Rh, the lower the NOx-T50 (i.e., the higher the NOx reducing performance). When the percentage of dissolved Rh was less than 17 wt %, a high NOx reducing performance was achieved. When the percentage of dissolved Rh was 3 wt % or less, a particularly high NOx reducing performance was achieved.

What is claimed is:

1. An exhaust gas purification device comprising:
a substrate including an upstream end through which an exhaust gas is introduced into the exhaust gas purification device and a downstream end through which the exhaust gas is discharged from the exhaust gas purification device;
a first catalyst layer formed in a first region, the first region extending between the downstream end and a first position, the first position being at a first distance from the downstream end toward the upstream end, the first catalyst layer containing a first rhodium-containing catalyst and a first cerium-containing oxide, the first rhodium-containing catalyst containing a first metal oxide carrier and first rhodium particles supported on the first metal oxide carrier, a mean of a particle size distribution of the first rhodium particles being from 2 nm to 10 nm, an amount of rhodium dissolved into the first metal oxide carrier to form a solid solution based on a total weight of rhodium contained in the first rhodium-containing catalyst being less than 17 wt %; and
a second catalyst layer formed in a second region, the second region extending between the upstream end and a second position, the second position being at a second distance from the upstream end toward the downstream end, the second catalyst layer containing second rhodium particles,
wherein a cerium content in the first catalyst layer based on a volume of the substrate in the first region is equal to or greater than a cerium content in the second catalyst layer based on a volume of the substrate in the second region.

2. The exhaust gas purification device according to claim 1,
wherein the amount of rhodium dissolved into the first metal oxide carrier to form a solid solution based on the total weight of rhodium contained in the first rhodium-containing catalyst is 3 wt % or less.

3. The exhaust gas purification device according to claim 1,
wherein the cerium content in the first catalyst layer based on the volume of the substrate in the first region is one to nine times the cerium content in the second catalyst layer based on the volume of the substrate in the second region.

4. The exhaust gas purification device according to claim 1,
wherein the second catalyst layer contains a second rhodium-containing catalyst containing a second metal oxide carrier and the second rhodium particles supported on the second metal oxide carrier.

5. A method for manufacturing an exhaust gas purification device, the method comprising:
(a) preparing a first rhodium-containing catalyst containing a first metal oxide carrier and first rhodium particles supported on the first metal oxide carrier;
(b) forming a first catalyst layer containing the first rhodium-containing catalyst and a first cerium-containing oxide in a first region extending between a downstream end of a substrate and a first position, the first position being at a first distance from the downstream end toward an upstream end; and
(c) forming a second catalyst layer containing second rhodium particles in a second region extending between the upstream end of the substrate and a second position, the second position being at a second distance from the upstream end toward the downstream end,
wherein the preparing the first rhodium-containing catalyst includes:
(i) impregnating the first metal oxide carrier with a rhodium compound solution;
(ii) drying the first metal oxide carrier impregnated with the rhodium compound solution to obtain a first rhodium-supporting metal oxide; and
(iii) heating the first rhodium-supporting metal oxide to a temperature within a range from 850° C. to 1000° C. in an atmosphere containing carbon monoxide at a concentration of 0.01 vol % to 5 vol % with a balance being an inert gas to obtain the first rhodium-containing catalyst, and
wherein a cerium content in the first catalyst layer based on a volume of the substrate in the first region is equal to or greater than a cerium content in the second catalyst layer based on a volume of the substrate in the second region.
